(19) United States
(12) Patent Application Publication
(10) Pub. No.: US 2020/0361283 A1
(43) Pub. Date: Nov. 19, 2020

(54) VEHICULAR AIR CONDITIONER

(71) Applicant: DENSO CORPORATION, Kariya-city (JP)

(72) Inventors: Yuya SUZUKI, Kariya-city (JP); Nobukazu KURIBAYASHI, Kariya-city (JP)

(21) Appl. No.: 16/985,679

(22) Filed: Aug. 5, 2020

Related U.S. Application Data
(63) Continuation of application No. PCT/JP2018/048543, filed on Dec. 28, 2018.

(30) Foreign Application Priority Data
Feb. 21, 2018 (JP) 2018-028657

(51) Int. Cl. B60H 1/00; B60H 3/00

(52) U.S. Cl. CPC B60H 1/00742; B60H 1/00357; B60H 3/0035; B60H 1/00978; B60H 1/00821

(57) ABSTRACT

A vehicular air conditioner is mounted in a vehicle. The vehicular air conditioner includes an awakening processing section configured to execute a control to awaken occupants in the vehicle by blowing air to the occupants. The awakening processing section is configured to execute a first awakening control to awaken only a driver at a first timing and a second awakening control to awaken at least one occupant of the occupants other than the driver at a second timing.

### CROSS REFERENCE TO RELATED APPLICATIONS

The present application is a continuation application of International Patent Application No. PCT/JP2018/048543 filed on Dec. 28, 2018, which designated the U.S. and claims the benefit of priority from Japanese Patent Application No. 2018-028657 filed on Feb. 21, 2018, the entire disclosure of which is incorporated herein by reference.

### TECHNICAL FIELD

The present disclosure relates to a vehicular air conditioner mounted in a vehicle.

### BACKGROUND

A vehicular air conditioner is configured to awaken the driver by blowing an air introduced from an outside into a vehicle cabin at a maximum flow rate when the driving mode shifts from an autonomous driving to a manual driving.

### SUMMARY

A vehicular air conditioner is mounted in a vehicle and includes an awakening processing section configured to execute a control to awaken occupants in the vehicle by blowing air to the occupants. The awakening processing section is configured to execute a first awakening control to awaken only a driver at a first timing and a second awakening control to awaken at least one of the occupants other than the driver at a second timing.

### BRIEF DESCRIPTION OF DRAWINGS

FIG. 1 is a diagram of an overall structure of a vehicle in which a vehicular air conditioner in an embodiment is mounted.

FIG. 2A is a schematic view illustrating a flow direction of air blown into a vehicle cabin in a first awakening control.

FIG. 2B is a schematic view illustrating a flow direction of air blown into a vehicle cabin in a second awakening control.

FIG. 3 is a flowchart of a series of a control executed from when the vehicle starts to travel to when the vehicle arrives at a destination.

FIG. 4 is a flowchart of a control executed by the vehicular air conditioner when the vehicle is traveling.

FIG. 5 is a flow chart of a control executed by the vehicular air conditioner when the vehicle is traveling.

### DESCRIPTION OF EMBODIMENTS

To begin with, examples of relevant techniques will be described.

It has been considered to provide a vehicular air conditioner with a function to awaken a driver. The vehicular air conditioner is configured to awaken the driver by blowing an air introduced from an outside into a vehicle cabin at a maximum flow rate when the driving mode shifts from an autonomous driving to a manual driving. Therefore, the driver can prepare for the manual driving. The function of the vehicular air conditioner to awaken the driver is particularly effective in an autonomous driving vehicle, but the function may be also used for a manual driving vehicle.

Usually, one or more occupant other than the driver often sits in the vehicle cabin. In this case, when the vehicular air conditioner executes a control to awaken the driver by blowing the outside air into the vehicle cabin, the air from the vehicular air conditioner is also blown to the occupant other than the driver. However, when the driving mode shifts from the autonomous driving to the manual driving, the occupant other than the driver is not necessarily awakened. In contrast, it is preferable to awaken the occupant other than the driver when the vehicle arrives at a destination. As described above, a timing at which the driver needs to be awakened is often different from a timing at which the occupant other than the driver needs to be awakened.

It is objective of the present disclosure to provide a vehicular air conditioner configured to awaken multiple occupants at appropriate timings.

A vehicular air conditioner according to the present disclosure is mounted in a vehicle and includes an awakening processing section configured to execute a control to awaken occupants in the vehicle by blowing air to the occupants. The awakening processing section is configured to execute a first awakening control to awaken only a driver at a first timing and a second awakening control to awaken at least one of the occupants other than the driver at a second timing.

The awakening processing section of the vehicular air conditioner executes the first awakening control to awaken only the driver and the second awakening control to awaken the at least one of occupants other than the driver. The awakening processing section is configured to execute the first awakening control at a first timing and the second awakening control at a second timing instead of executing them at the same timing. Thus, it is possible to awaken the multiple occupants at different, appropriate timings.

“The control to awaken the occupants in the vehicle by bowing air to the occupants” may be a control to blow a cool air or a large amount of air directly to bodies of the occupants or a control to blow air having pungent odor to the occupants.

According to the present disclosure, a vehicular air conditioner configured to awaken multiple occupants at different, appropriate timings is provided.

Hereinafter, the present embodiments will be described with reference to the attached drawings. In order to facilitate the ease of understanding, the same reference numerals are attached to the same constituent elements in each drawing where possible, and redundant explanations are omitted.

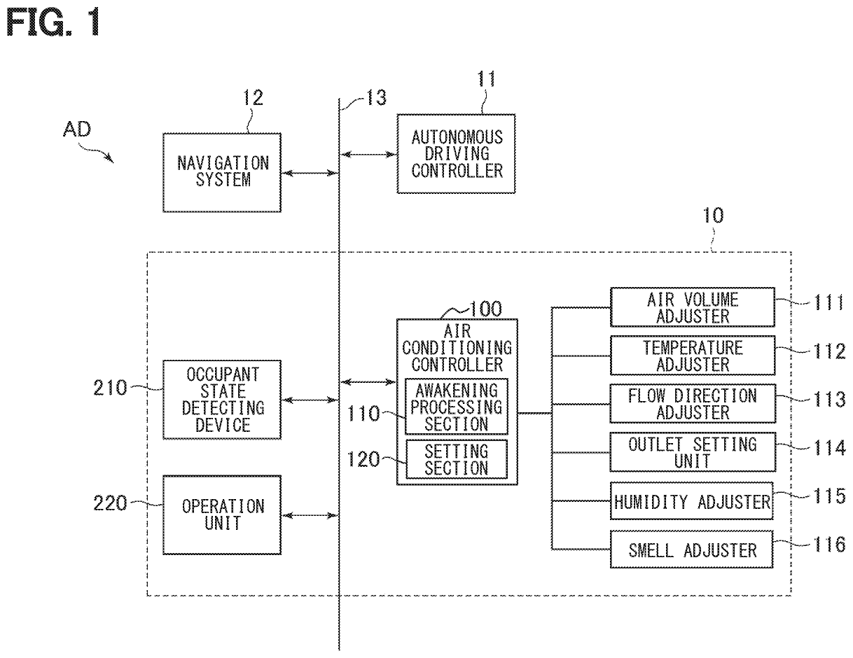

A vehicular air conditioner 10 in this embodiment is mounted in a vehicle AD and configured to perform an air conditioning in a vehicle cabin RM of the vehicle AD. Prior to describing the vehicular air conditioner 10, a configuration of the vehicle AD will be briefly described with reference to FIG. 1.

The vehicle AD is configured as an autonomous driving vehicle and capable of traveling, without a manual operation by the driver, by automatically performing operations such as steering, acceleration, and deceleration when a specific condition is satisfied. In other cases, the vehicle AD travels in accordance with operations manually performed by the driver. In this way, the vehicle AD is capable of performing both the autonomous driving and the manual driving. The above-mentioned “when the specific condition is satisfied” may be when the vehicle AD is traveling on an expressway.

The vehicle AD includes an autonomous driving controller 11 and a navigation system 12. These constitute a computer system having a CPU, a ROM, a RAM, and the like.

The autonomous driving controller 11 is configured to execute a control necessary for the autonomous driving of the vehicle AD. When the vehicle AD performs the autonomous driving, the autonomous driving controller 11 controls an electric steering device, an electric brake, and a driving force adjuster of the vehicle AD (all not shown) to automatically drive the vehicle AD.

The autonomous driving controller 11 also executes a control to switch a driving mode of the vehicle AD from the autonomous driving to the manual driving or from the manual driving to the autonomous driving. For example, when the vehicle AD enters an expressway from a city area, the autonomous driving controller 11 switches the manual driving to the autonomous driving. When an emergency situation such as an accident by another vehicle near the vehicle AD occurs, the autonomous driving controller 11 switches the autonomous driving to the manual driving. Circumstances around the vehicle AD can be recognized based on images captured by an in-vehicle camera (not shown) and information transmitted from an outside traffic control system.

The autonomous driving controller 11 is configured to bidirectionally communicate with the navigation system 12 through a communication network 13 provided in the vehicle AD. For example, the autonomous driving controller 11 obtains information on a travelling route from the navigation system 12 and determines a timing at which the autonomous driving is switched to the manual driving based on the travelling route. The autonomous driving controller 11 controls the vehicle AD to travel along the traveling route obtained as described above and transmits information as to whether the vehicle is in the autonomous driving or not to an air conditioning controller 100 in response to requests.

The navigation system 12 is configured to calculate a traveling route based on location information of the vehicle AD obtained by GPS and guide the vehicle to a destination along the traveling route. The navigation system 12 can bidirectionally communicate through the communication network 13 as with the autonomous driving controller 11. The navigation system 12 transmits information on the travelling route calculated as described above to the autonomous driving controller 11 and the air conditioning controller 100 through the communication network 13.

The detailed configuration of the vehicular air conditioner 10 will be described with reference to FIG. 1. The vehicular air conditioner 10 includes the air conditioning controller 100, an air volume adjuster 111, a temperature adjuster 112, a flow direction adjuster 113, a blowing outlet setting unit 114, a humidity adjuster 115, a smell adjuster 116, an occupant state detecting device 210, and an operation unit 220.

The air conditioning controller 100 controls an overall operation of the vehicular air conditioner 10. The air conditioning controller 100 constitutes a computer system having a CPU (i.e., a processor), a ROM, a RAM, and the like. The air conditioning controller 100 includes an awakening processing section 110 and a setting section 120 as functional control blocks.

The awakening processing section 110 is configured to execute a control to awaken occupants in the vehicle AD by blowing air into the vehicle cabin RM. That is, the air conditioning controller 100 is configured not only to perform an air conditioning to keep an appropriate temperature in the vehicle cabin RM but also to execute a control to awaken the driver and/or other occupants with the awakening processing section 110. The detail of the control executed by the awakening processing section 110 will be described later.

The setting section 120 is configured to set, for each of seats of the occupants in the vehicle AD, an intensity of a stimulus given to the occupants during the control to awaken the occupants executed by the awakening processing section 110. The setting section 120 also stores the intensity of the stimulus. “The intensity of the stimulus” may be a flow rate of air blown to the occupants.

For example, if a child seat is attached to a rear seat of the vehicle AD, it is preferable to set the intensity such that air for awakening occupants is not blown to the rear seat on which the child seat is attached. Additionally, it is preferable to set the intensity such that a small amount of air reaches a seat on which an occupant who does not like a strong stimulus is seated. The setting section 120 is configured to set, for each of seats, an intensity as described above based on the operation of the operation unit 220 by the occupants.

The air volume adjuster 111 is configured to adjust a flow rate of air blown into the vehicle cabin RM. The air volume adjuster 111 is specifically a blower motor. The air volume adjuster 111 changes a rotational speed of the blower motor based on control signals from the air conditioning controller 100 to adjust the flow rate of air blown into the vehicle cabin RM.

The temperature adjuster 112 is configured to adjust a temperature of air blown into the vehicle cabin RM. The temperature adjuster 112 may be specifically an air mix door. The temperature adjuster 112 adjusts the temperature of the air blown into the vehicle cabin RM by adjusting a ratio of a flow rate of air passing only through an evaporator (not shown) to a flow rate of air passing through both the evaporator and a heater core (not shown). The temperature adjuster 112 changes an opening degree of the temperature adjuster 112 based on control signals from the air conditioning controller 100 to adjust the temperature of air blown into the vehicle cabin RM.

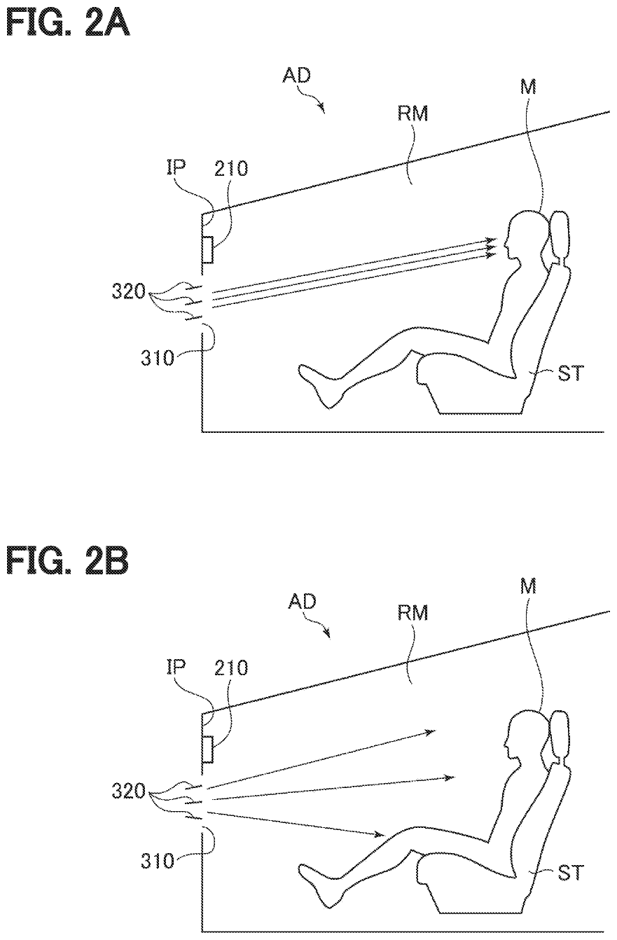

The flow direction adjuster 113 is configured to adjust a flow direction of air blown into the vehicle cabin RM by adjusting angles of louvers 320 located at blowing outlets 310 (see FIG. 2). In this embodiment, the blowing outlets 310 and the louvers 320 are provided for the corresponding seat in the vehicle AD. The flow direction adjuster 113 is configured to separately adjust directions of air blown through the blowing outlets 310 by adjusting angles of the louvers 320. As will be described later, the flow direction adjuster 113 is further configured to adjust a degree of diffusion of air blowing through the blowing outlets 310. The flow direction adjuster 113 adjusts the flow direction and the degree of diffusion of air blown through each of the blowing outlets 310 by changing orientations of the louvers 320 based on control signals from the air conditioning controller 100.

The blowing outlet setting unit 114 switches, for each of blowing outlets 310 provided for the corresponding seat, between a state in which air is blown through the blowing outlets 310 and a state in which air is not blown through the blowing outlets 310. The air conditioning mechanism includes ducts (not shown) connected to the blowing outlets 310 and each duct has a door configured to selectively open and close a passage of the duct at an upstream end of the duct. The blowing outlet setting unit 114 controls the door to selectively open and close the passage based on control signals from the air conditioning controller 100. As a result, air can be blown only to a target seat.

The humidity adjuster 115 is configured to adjust a humidity of air blown into the vehicle cabin RM. The humidity adjuster 115 humidifies air blown into the vehicle cabin RM by adding mist water based on control signals from the air conditioning controller 100.

The smell adjuster 116 is configured to add smell to air blown into the vehicle cabin RM. The smell adjuster 116 adds mist of a smell component to air blown into the vehicle cabin RM based on control signals from the air conditioning controller 100. In this embodiment, two types of smell components having different intensity of stimulus are used. One is a component having pungent odor such as wasabi smell. The other one is an aroma component having smell such as scents of trees. The smell adjuster 116 adds one of the two types of smell designated by control signals from the air conditioning controller 100 to air blown to the seat that is also designated by the control signals.

The occupant state detecting device 210 is configured to detect a presence of the occupant on each seat and an awakening state of the occupant. The occupant state detecting device 210 is specifically a camera that captures images in the vehicle cabin RM. As shown in FIGS. 2A and 2B, the occupant state detecting device 210 is attached at a front side of an instrument panel IP to face a rear side of the instrument panel IP. The occupant state detecting device 210 analyzes the images of the vehicle cabin RM captured by the camera and detects whether the occupant is awake or not. The information obtained from the occupant state detecting device 210 is transmitted to the air conditioning controller 100 through the communication network 13. The occupant state detecting device 210 may be attached to a vicinity of a rear view mirror.

The operation unit 220 is configured to be operated by the occupant and may be specifically a touch panel screen located in the vehicle cabin RM. The occupant can perform various settings for controlling the air conditioning controller 100 by manipulating the operation unit 220. The information on the operations of the operation unit 220 is transmitted to the air conditioning controller 100 through the communication network 13.

Here, a control executed by the awakening processing section 110 will be described. As described above, the awakening processing section 110 executes the control to awaken the occupants in the vehicle AD by blowing air into the vehicle cabin RM. In this embodiment, the awakening processing section 110 is configured to execute two types of controls. One is a control to awaken an occupant seated on a driving seat (i.e., a driver). Hereinafter, this control is referred to as a “first awakening control”. The other one is a control to awaken an occupant seated on a seat other than the driver seat (i.e., the occupant other than the driver). Hereinafter, this control is referred to as a “second awakening control”. The awakening processing section 110 is configured to execute the first awakening control at a first timing and the second awakening control at a second timing. The awakening processing section 110 can also execute the first awakening control and the second awakening control at the same timing.

In the first awakening control, the air conditioning controller 100 blows air only through the blowing outlet 310 disposed at a front side of the driver seat. In this case, air blown through the blowing outlet 310 by the air conditioning controller 100 is blown only to the driver, thus the driver is awakened. On the other hand, the air blown by the air conditioning controller 100 is not blown to the occupant other than the driver, so that the occupant is not awakened unnecessarily.

In the second awakening control, air is blown only through the blowing outlet 310 located at a front side of the seat other than the driver seat. In this case, air blown through the blowing outlet 310 by the air conditioning controller 100 is blown to the occupants other than the driver to awaken the occupants. Thus, all occupants other than the driver are awakened at the second timing different from the first timing at which the driver is awakened. The second timing may be a timing at which the vehicle AD reaches the destination.

As described above, the blowing outlet setting unit 114 performs the control to selectively blow air through one or more blowing outlet 310.

In this embodiment, the first awakening control is executed in a different manner from the second awakening control. In FIGS. 2A and 2B, the occupant is indicated by a symbol M and a seat for the occupant is indicated by a symbol ST.

FIG. 2A is a schematic view illustrating a state in which the first awakening control is executed for the driver. In the first awakening control, a direction of air is adjusted such that air blown through the blowing outlet 310 is adjusted to have one direction and the air blown through the blowing outlet 310 is directed toward a target area such as a face of the driver. During the first awakening control, an area of the driver receiving the air is relatively narrow. The area of the driver receiving the air is referred to as a “first area”. The first area may be an entire face of the driver or a neck of the driver.

FIG. 2B is a schematic view illustrating a state in which the second awakening control is executed for an occupant other than the driver. In the second awakening control, a direction of air is adjusted such that air blown through the blowing outlet 310 diffuses in a wide range and the air is adjusted to be blown toward an entire body of the occupant. That is, the diffused area of air blown through the blowing outlet 310 in the second awakening control is wider than that in the first awakening control. The area of the occupant receiving air is referred to as a “second area” and the second area is wider than the first area. The second area may be the entire body of the occupant or a partial area of the body of the occupant other than the face. The direction of air blown through the blowing outlet 310 and the degree of diffusion may be adjusted by the louvers 320 or other means.

As described above, in this embodiment, the first awakening control is executed in a different manner from the second awakening control. In the first awakening control, the awakening processing section 110 has the driver awaken and concentrate on driving by giving a relatively strong stimulus to the driver. On the contrary, in the second awakening, the awakening processing section 110 has the occupant other than the driver awaken gently and comfortably by giving a relatively weak stimulus to the occupant.

It should be noted that the contents of the first awakening control and the second awakening control may be different from above-mentioned contents. For example, the awakening processing section 110 may be configured to execute the first awakening control by blowing a cool air having a first temperature to the driver and the second awakening control by blowing a cool air having a second temperature to the occupant other than the driver. The second temperature is higher than the first temperature. Thus, the driver and the other occupants can be awakened in an appropriate manner.

In addition, the awakening processing section 110 may be configured to execute the first awakening control by blowing a large amount of air to the driver and the second awakening control by blowing a small amount of air to the occupant other than the driver. The driver and the other occupants can be awakened in an appropriate manner.

Further, the awakening processing section 110 may be configured to execute the first awakening control by blowing air having pungent odor to the driver and the second awakening control by blowing air having an aroma component to the occupant other than the driver. That is, air having smaller stimulus is blown to the occupant other than the driver during the second awakening control. Thus, the driver and the other occupants can be awakened in an appropriate manner.

The awakening processing section 110 may be configured to execute the first awakening control by blowing air having a first humidity to the driver and the second awakening control by blowing air having a second humidity to the occupant other than the driver. The first humidity is relatively low and the second humidity is higher than the first humidity, i.e., air having smaller stimulus is blown during the second awakening control as compared to the first awakening control. Thus, the driver and the other occupants can be awakened in an appropriate manner.

In this embodiment, the occupant operates the operation unit 220 to set intensities of stimulus, for each of the seats, during the first awakening control and the second awakening control according to preference. As described above, the setting section 120 is configured to set the intensities of stimulus. That is, the setting section 120 is configured to set, for each of seats of the occupants, an intensity of a stimulus given to the occupants during the first awakening control and the second awakening control.

For example, when the occupant seated on a seat other than the driver seat operates the operation unit 220 to increase the intensity of the stimulus for the seat during the second awakening control, the awakening processing section 110 reduces a degree of diffusion of air blown to the seat compared to the degree of diffusion of air blown to other seat. Accordingly, the stimulus given to the occupant is increased as set by the occupant.

The occupant can operate the operation unit 220 to cancel the execution of the second awakening control for the seat. The setting section 120 also stores such setting of cancellation.

For example, when the execution of the second awakening control for an occupant seated on the corresponding seat has been cancelled, the awakening processing section 110 refrains from executing the second awakening control for the occupant even when the second timing to execute the second awakening control comes. The occupant may be an infant sitting on a child seat.

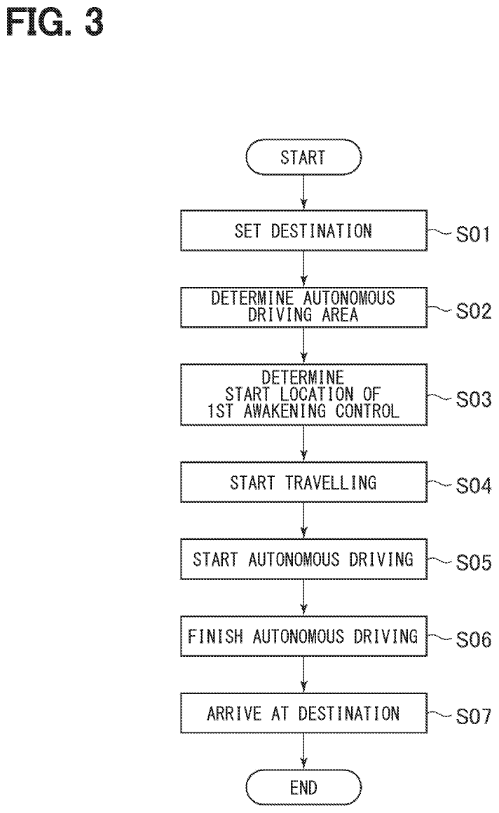

FIG. 3 is a flowchart illustrating series of a control executed from when the vehicle AD starts travelling to when the vehicle AD arrives at the destination. In step S01, the destination of the vehicle AD is set in the navigation system 12. The occupant operates the operation unit 220 to perform a process of step S01. After the occupant performs this process, the navigation system 12 calculates a traveling route of the vehicle AD according to the destination. The navigation system 12 transmits the calculated traveling route to the autonomous driving controller 11 and the air conditioning controller 100.

In step S02 after step S01, an area in which the vehicle AD autonomously travels along the travelling route is set. The area is referred to as an “autonomous driving area”. The process is performed by the autonomous driving controller 11 but may be performed by the navigation system 12. The autonomous driving area is set to be an area in which a complex driving operation is not needed, such as an area including an expressway in the traveling route. The autonomous driving area is transmitted to the air conditioning controller 100.

In step S03 after step S02, the awakening processing section 110 determines a first location at which the first awakening control will be executed and a second location at which the second awakening control will be executed. The awakening processing section 110 sets the first location to be a start point of the autonomous driving area or a location close to the start point. The awakening processing section 110 sets the second location to be the destination or a location close to the destination of the traveling route. In this embodiment, the awakening processing section 110 determines both the first location and the second location, but may determine only one of the locations.

The awakening processing section 110 in this embodiment determines at least one of the location at which the first awakening control will be executed and the location at which the second awakening control will be executed based on the traveling route of the vehicle AD set by the navigation system 12.

In step S04 after S03, the vehicle AD starts to travel. In many cases, the vehicle AD starts to travel in manual driving. After that, when the vehicle AD reaches the autonomous driving area, the process proceeds to step S05 and the manual driving is switched to the autonomous driving. During a period from step S01 to step S05, the air conditioning controller 100 performs an air conditioning for making the vehicle cabin RM comfortable (i.e., a normal air conditioning).

When the vehicle AD exits the autonomous traveling area, the process proceeds to step S06, and the autonomous driving is switched to the manual driving.

When the process proceeds to step S06, the driver starts to drive the vehicle. Since the driver may have a low arousal level at this time after the autonomous traveling, it may be dangerous for the driver to manually drive the vehicle AD.

Therefore, in the vehicular air conditioner 10 in this embodiment, the awakening processing section 110 executes the first awakening control at a timing just before the autonomous driving is switched to the manual driving to surely awaken the driver. Specifically, the awakening processing section 110 executes the first awakening control a few minutes before the manual driving starts. Since air blown by the vehicular air conditioner 10 is not blown to occupants other than the driver, the occupants other than the driver are not awakened unnecessarily.

In step S07 subsequent to step S06, the vehicle AD arrives at the destination. At this time, the awakening processing section 110 executes the second awakening control to awaken all occupants other than the driver. As described above, a stimulus given to the occupants at this time is smaller than a stimulus given to the driver during the first awakening control. Thus, the occupants other than the driver are awakened gently and comfortably.

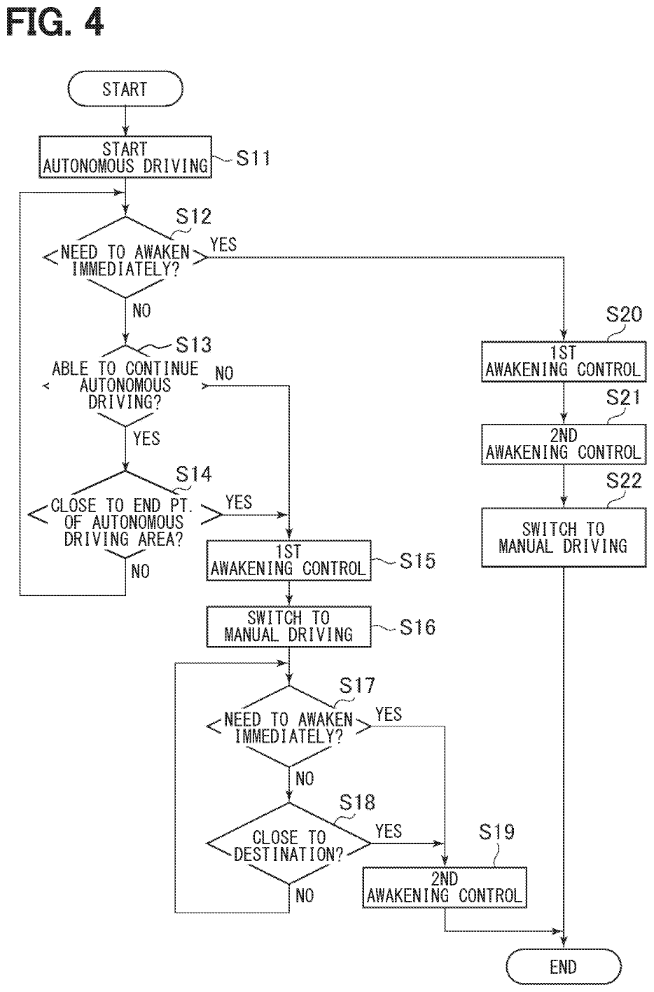

With reference to FIG. 4, a flow of the control executed by the air conditioning controller 100 will be described. A series of the control in FIG. 4 starts at a time when the vehicle AD reaches the autonomous driving area.

In step S11 of this process, the autonomous driving controller 11 controls the vehicle AD to start the autonomous driving. In step S12 after step S11, it is determined whether all occupants including the driver need to be immediately awakened. The all occupants need to be immediately awakened when an emergency situation occurs and the occupants need to escape from the vehicle. Such an emergency situation may also be, for example, an accident occurrence around the vehicle AD or a disaster such as an earthquake. When such an emergency situation does not occur, the process proceeds to step S13.

In step S13, it is determined whether the vehicle AD can continue the autonomous driving. The vehicle AD cannot continue the autonomous driving when the vehicle AD has a difficulty to continue the autonomous driving normally. For example, such situations includes when an obstacle is present on the expressway and when a traffic restriction is imposed on the expressway. If the vehicle AD can continue autonomous driving, the process proceeds to step S14.

In step S14, it is determined whether the vehicle AD reaches a location close to an end point of the autonomous driving area. The location close to the end point of the autonomous driving area is the location, set in step S03, at which the first awakening control is to be executed. When the vehicle AD has not reached the location close to the end point of the autonomous driving area, a process after step S12 is repeated.

When the vehicle AD arrives at the location close to the end point of the autonomous driving area, the process proceeds to step S15. When it is determined that the vehicle AD cannot continue the autonomous driving in step S13, the process proceeds to step S15.

When the process proceeds to step S15, the autonomous driving is switched to the manual driving. In step S15, the first awakening control is executed. As a result, the driver is immediately awakened to be in a suitable mental state for driving.

As described above, the awakening processing section 110 in this embodiment executes the first awakening control not only when a determination in step S14 is yes (i.e., the vehicle AD passes the end point of the autonomous driving area as scheduled), but also when the vehicle AD is determined not to be able to continue the autonomous driving.

In step S16 after step S15, the autonomous driving controller 11 switches the driving mode from the autonomous driving to the manual driving. After step S16, the vehicle AD travels based on manual operation by the driver.

In step S17 after step S16, it is determined whether all occupants need to be immediately awaken. The determination in this step is the same as the determination in step S12. When all occupants need not be immediately awaken, the process proceeds to step S18.

In step S18, it is determined whether the vehicle AD arrives at a location close to the destination. “The location close to the destination” is the location, set in step S03 in FIG. 3, at which the second awakening control is to be executed. When the vehicle AD has not arrived at the location close to the destination, the process after the step S17 is repeated.

When the vehicle AD arrives at the location close to the destination, the process proceeds to step S19. Also, when it is determined that all occupants need to be immediately awakened at step S17, the process proceeds to step S19. In step S19, the second awakening control is executed. Thus, the occupants other than the driver are awakened gently and comfortably. In the emergency situation (i.e., step S17: Yes), the vehicular air conditioner 10 may increase a stimulus given to the occupants during the second awakening control to immediately awaken all occupants. This applies to step S21, as will be described later.

When it is determined that all occupants need to be awaken immediately at step S12, the process proceeds to step S20. In step S20, the first awakening control is executed. In step S21 after S20, the second awakening control is executed. Thereby, all occupants are awakened. The process in step S20 and step S21 may be performed in the reverse order or at the same time.

In step S22 after step S21, the autonomous driving controller 11 switches the driving mode from the autonomous driving to the manual driving. Thus, the driver can respond to the emergency situation by manually operating the vehicle AD. When the vehicle AD travels automatically to avoid the emergency situation and automatically stops, and when the occupants are urged to escape from the vehicle AD, the process in step S22 may not be performed.

As described above, when the autonomous driving is switched to the manual driving at an unexpected timing because of an emergency situation, the first awakening control is performed at the same timing of switching the driving mode from the autonomous driving to the manual driving.

The first awakening control in step S15 and S20 and the second awakening control in step S19 and S21 are executed such that the stimulus given to a target occupant has the intensity set by the setting section 120.

When the occupant state detecting device 210 detects that the driver who is a target of the first awakening control has been awake at step S15 and S20, the awakening processing section 110 may not execute the first awakening control. Similarly, when the occupant state detecting device 210 detects that the occupant who is a target of the second awakening control has been awake at step S19 and S21, the awakening processing section 110 may not execute the second awakening control for the occupant. Thus, the vehicular air conditioner 10 reduces an unnecessary operation.

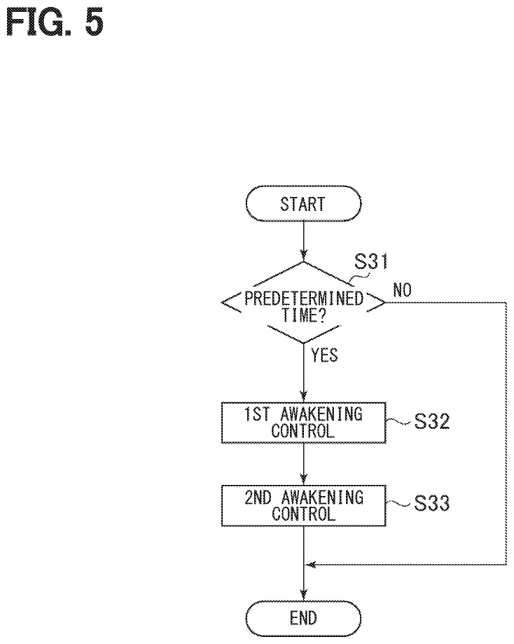

The awakening processing section 110 in this embodiment executes the first awakening control and the second awakening control at the timings as described above, but the awakening processing section 110 may execute the first awakening control and the second awakening control at a predetermined schedule time inputted by the occupant. This will be described with reference to FIG. 5. Series of the process in FIG. 5 is a control repeatedly executed by the air conditioning controller 100 along with the series of the process in FIG. 4.

In first step S31, it is determined whether a predetermined schedule time comes. The occupant has set the predetermined time by operating the operation unit 220. The predetermined schedule time may be a time for taking a restroom break or a time for eating. When the predetermined schedule time has not come, the series of the process shown in FIG. 5 is ended. When the predetermined schedule time has come, the process proceeds to step S32.

In step S32, the first awakening control is executed. In step S33 after step S32, the second awakening control is executed. In this embodiment, the first awakening control and the second awakening control are simultaneously executed at the predetermined schedule time. Instead, only one of the first awakening control and the second awakening control may be executed at the predetermined schedule time.

The first awakening control and the second awakening control may be executed at different timings. That is, the occupant may separately input and set a first predetermined time for the first awakening control and a second predetermined time for the second awakening control.

The present embodiments have been described above with reference to concrete examples. However, the present disclosure is not limited to those specific examples. Those specific examples that are appropriately modified in design by those skilled in the art are also encompassed in the scope of the present disclosure, as far as the modified specific examples have the features of the present disclosure. Each element included in each of the specific examples described above and the arrangement, condition, shape, and the like thereof are not limited to those illustrated, and can be changed as appropriate. The combinations of elements included in each of the above described specific examples can be appropriately modified as long as no technical inconsistency occurs.

What is claimed is:

1. A vehicular air conditioner mounted in a vehicle, the vehicular air conditioner comprising:
an awakening processing section configured to execute a control to awaken occupants in the vehicle by blowing air to the occupants, wherein
the awakening processing section is configured to execute:
a first awakening control to awaken only a driver at a first timing; and
a second awakening control to awaken at least one occupant of the occupants other than the driver at a second timing.

2. The vehicular air conditioner according to claim 1, wherein
the awakening processing section is configured to execute the first awakening control in a different manner from the second awakening control.

3. The vehicular air conditioner according to claim 2, wherein
the awakening processing section is configured to execute:
the first awakening control by blowing air to a first area of the driver; and
the second awakening control by blowing air to a second area of the at least one occupant other than the driver, and
the second area is wider than the first area.

4. The vehicular air conditioner according to claim 2, wherein
the awakening processing section is configured to execute:
the first awakening control by blowing a large amount of air to the driver; and
the second awakening control by blowing a small amount of air to the at least one occupant other than the driver.

5. The vehicular air conditioner according to claim 2, wherein
the awakening processing section is configured to execute:
the first awakening control by blowing air having pungent smell to the driver; and
the second awakening control by blowing air including an aroma component to the at least one occupant other than the driver.

6. The vehicular air conditioner according to claim 2, wherein
the awakening processing section is configured to execute:
the first awakening control by blowing a cool air having a first temperature to the driver; and
the second awakening control by blowing a cool air having a second temperature to the at least one occupant other than the driver, wherein
the second temperature is higher than the first temperature.

7. The vehicular air conditioner according to claim 2, wherein
the awakening processing section is configured to execute:
the first awakening control by blowing air having a first humidity to the driver; and
the second awakening control by blowing air having a second humidity to the at least one occupant other than the driver, wherein
the second humidity is higher than the first humidity.

8. The vehicular air conditioner according to claim 1, wherein
the vehicle is capable of switching between an autonomous driving and manual driving, and
the awakening processing section is configured to execute the first awakening control when or just before the vehicle switches from the autonomous driving to the manual driving.

9. The vehicular air conditioner according to claim 8, wherein
the vehicle includes a navigation system by which a traveling route for the vehicle is set, and
the awakening processing section is configured to determine, based on the traveling route for the vehicle, at least one of a location at which the first awakening control will be executed and a location at which the second awakening control will be executed.

10. The vehicular air conditioner according to claim 8, wherein
the awakening processing section is configured to execute the first awakening control upon determining that the vehicle is not able to continue the autonomous driving.

11. The vehicular air conditioner according to claim 8, wherein
the awakening processing section is configured to execute at least one of the first awakening control and the second awakening control at a predetermined schedule time.

12. The vehicular air conditioner according to claim 1, wherein
the awakening processing section is configured to refrain from executing:
the first awakening control when the driver has been already awake; and
the second awakening control when the at least one occupant has been already awake.

13. The air conditioner according to claim 1, wherein
the awakening processing section is configured to refrain from executing the second awakening control for a predetermined occupant when the second awakening control for the predetermined occupant has already been canceled.

14. The air conditioner according to claim 1, further comprising
a setting section configured to set, for each of seats of the occupants, an intensity of a stimulus given to the occupants during the first awakening control and the second awakening control.

15. A vehicular air conditioner mounted in a vehicle, the vehicular air conditioner comprising:
one or more processors programmed to execute:
a first awakening control to awaken only a driver in the vehicle at a first timing; and
a second awakening control to awaken an occupant in the vehicle other than the driver at a second timing.

16. The vehicular air conditioner according to claim 15, wherein
the vehicle is capable of switching between an autonomous driving and a manual driving, and
the one or more processors are programmed to execute the first awakening control when or just before the vehicle switches from the autonomous driving to the manual driving.

17. The vehicular air conditioner according to claim 16, wherein
the vehicle includes a navigation system coupled to the one or more processors to communicate with each other, the navigation system by which a traveling route for the vehicle is determined, and
the one or more processors are programmed to determine, based on the traveling route for the vehicle, at least one of a location at which the first awakening control will be executed and a location at which the second awakening control will be executed.

18. The vehicular air conditioner according to claim 16, wherein
the one or more processors are programmed to:
determine whether the vehicle is able to continue the autonomous driving; and
execute the first awakening control upon determining that the vehicle is not able to continue the autonomous driving.

19. The vehicular air conditioner according to claim 15, wherein
the one or more processors are programmed to:
determine whether the driver has been already awake and whether the occupant other than the driver has been already awake; and
refrain from executing the first awakening control upon determining the driver has been already awake and from executing the second awakening control upon determining the occupant has been already awake.

20. The vehicular air conditioner according to claim 15, wherein
the one or more processors are programmed to set, for each of seats of the occupants, an intensity of a stimulus given to the occupants during the first awakening control and the second awakening control.
